(19) United States
(12) Patent Application Publication
(10) Pub. No.: US 2010/0094780 A1
(43) Pub. Date: Apr. 15, 2010

(54) SIGNAL PROCESSING APPARATUS

(76) Inventor: Jan Trzcinski, Co Kildare (IE)

Correspondence Address: CHOATE, HALL & STEWART LLP, TWO INTERNATIONAL PLACE, BOSTON, MA, 02110, US

(21) Appl. No.: 12/513,781

(22) PCT Filed: Nov. 1, 2007
(86) PCT No.: PCT/IE2007/000107

§ 371 Date: Dec. 21, 2009

(30) Foreign Application Priority Data
Nov. 7, 2006 (GB) 0622208.7

(51) Int. Cl. G06F 17/00; G06F 7/00

(52) U.S. Cl. 705/417; 701/33

(57) ABSTRACT

A signal processing apparatus for a taxi meter comprises a processor (108) and a plug (122). The plug (122) connects to a vehicle's (100) diagnostic system (116) and receives an incoming electrical signal from the vehicle's diagnostic system (116). The signal passes to the processor (108), the processor which convert the signal to distance data indicative of a distance travelled. The processor (108)interprets the distance data into a form suitable for reading by a taximeter and transmits the interpreted distance data to a taximeter.

This invention relates to a signal processing apparatus. More particularly, but not exclusively, it relates to a signal processing apparatus for a taxi meter, comprising a connection to a vehicle's diagnostic system.

Taxi meters are employed to determine the fare due for a journey. Typically, a fare will comprise fixed elements, a time element and a distance element. The fixed elements can comprise payment for such things as the number of passengers and the number of items of luggage undertaking the journey. Usually, these fixed elements are entered by the taxi driver directly. Typically, the time element comprises payment for time when the taxi is waiting, for example when in traffic. The distance element is dependent upon the distance travelled.

Modern taxi meters are electronic and obtain a measure of the distance travelled by connecting electrically to the vehicle's odometer system. The installation of such a taxi meter is a complex, skilled and time consuming process, often taking a skilled installer a number of hours to complete.

Electrical connections must be made directly to the vehicle's electronic circuit boards or wiring with the attendant possibility of damaging the vehicle's circuitry. Such an installation may also invalidate a manufacturer's warranty for the vehicle. This is clearly undesirable from the perspective of the vehicle's owner.

According to a first aspect of the present invention there is provided a signal processing apparatus for a taxi meter comprising processing means and connection means, the connection means being arranged to connect to a vehicle's diagnostic system, the connection means being arranged to receive said incoming electrical signal from the vehicle's diagnostic system and to pass said incoming electrical signal to the processing means, the processing means being arranged to convert an incoming electrical signal from a vehicle's diagnostic system to distance data indicative of a distance travelled, the processing means being further arranged to interpret distance data into a form suitable for reading by a taximeter, and being further arranged to transmit said interpreted distance data.

The connection of a complimentary connection of the vehicle's diagnostic system to an input connection of the taxi meter simplifies the connection of the taxi meter to the vehicle. This reduces the time required to install the taxi meter compared to the prior art and also reduces the likelihood of damaging the vehicle's electrical circuitry. In addition, the use of a pre-existing connection of the vehicle's diagnostic system that is installed by the vehicle manufacturer reduces the likelihood of the installation prejudicing the vehicle owner's warranty.

The signal processing apparatus may be arranged to connect to the vehicle's diagnostic system via a connector that is complimentary to that of the vehicle's diagnostic system,

The connection means may be a controller area network (CAN) connector. The connection means may comprise a shaped end-piece shaped complimentarily to the connector of the vehicle's diagnostic system. The end piece and the connector may be arranged to frictionally engage. The connection means may comprise a plug or a socket arranged to engage with a socket or a plug of the vehicle's diagnostic system.

The incoming electrical signal may comprise odometer data.

The connection means may be arranged to carry a voltage from the vehicle's diagnostic system, for example to power illuminated signage.

The processor may be arranged to convert said distance data to distance value data indicative of a monetary value associated with said distance data and being further arranged to add further value data to said distance value data if appropriate to yield a total value data. The taximeter may comprise display means arranged to display said total value data,

The processor may be arranged to output an analogue signal.

According to a second aspect of the present invention there is provided a method of reducing off road time of a taxi comprising fitting a signal processing apparatus according to the first aspect of the present invention to a vehicle in accordance with the method of the first aspect of the present invention.

According to a third aspect of the present invention there is provided a method of increasing revenue derived from a taxi comprising reducing the off road time of a taxi in accordance with the method of second aspect of the present invention.

The invention will now be described, by way of example only, with reference to the accompanying drawings, in which:

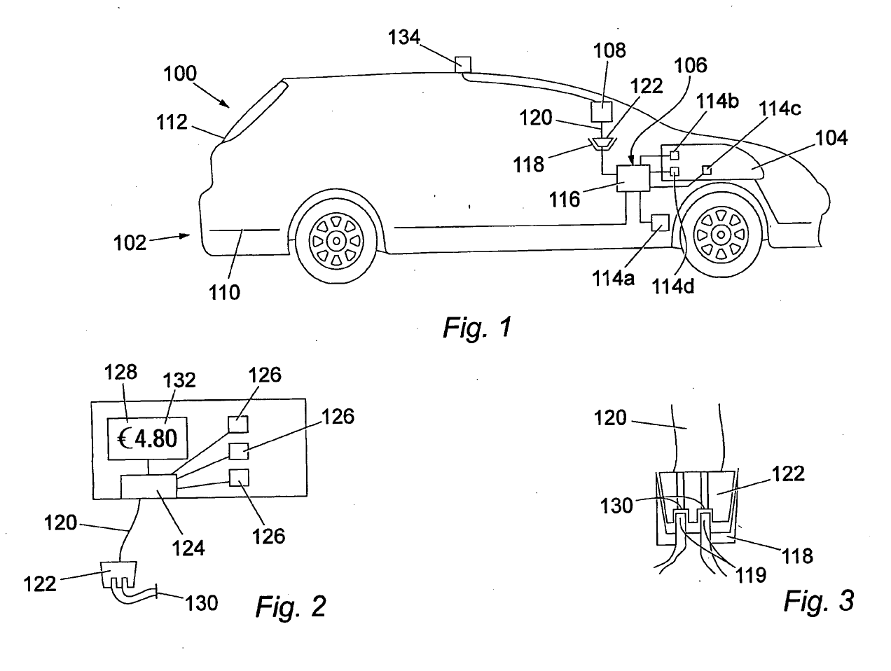

FIG. 1 is a schematic diagram of a motor vehicle comprising a taxi meter according to an aspect of the present invention;

FIG. 2 is a block diagram showing components of a taxi meter according to an aspect of the present invention;

FIG. 3 is a schematic diagram showing a connector of a taxi meter according to an aspect of the present invention connected to a connector of a diagnostic system of the vehicle of FIG. 1;

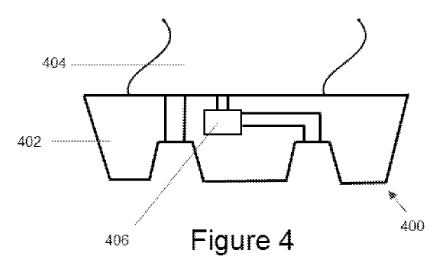

FIG. 4 is a schematic diagram of a converter according to a further aspect of the present invention.

Referring now to FIGS. 1 to 3, motor vehicle 100 comprises a car body 102, an engine 104, a diagnostic system 106 and a taxi meter 108.

The body 102 comprises a chassis 110 that supports the engine 104 and body panels 112. The engine 104 connects to the diagnostic system 106 such that parameters of engine performance and odometer values are logged by the diagnostic system 106. The logging of these parameters and odometer values is achieved in a manner known to one skilled in the art. Typically, the diagnostic system comprises a CAN data bus operates in a manner which is known to one skilled in the art. Usually, the CAN data bus operates a data transmission rate of 1 Mbits⁻¹.

The diagnostic system 106 comprises a plurality of sensors 114a-d, a processor 116 and an output port 118. The sensors 114a-d are distributed about the engine 104, and other salient points within the vehicle 100 such that parameter values such as engine temperature, speed, distance travelled are captured by the diagnostic system 106.

The parameter values are processed at the processor 116 and are fed to the output port 118, typically in real time. Typically, the output port 118 comprises a plurality of discrete signal carrying terminals 119. Each terminal 119 receives a signal corresponding to either an output from a sensor 114a-d, or a combination of outputs from the sensors 114a-d, or a voltage signal. Typically, the output port 118 is located in vehicle cabin, usually at a height where it is accessible easily by an unskilled installer.

The taxi meter 108 comprises a connecting lead 120 having an end piece 122, a processor 124, input buttons 126 and a display 128. The end piece 122 is shaped complimentarily to the output port 118 of the diagnostic system 106 and is complimentarily male or female to the output port 118. The end piece 122 has terminals 130 that are arranged to connect electrically with the terminals 119 of the output port 118 of the diagnostic system 106. The lead 120 carries signals between the processor 124 and the end piece 122.

In use, the input buttons 126 are used to toggle the taxi meter 108 between on and off states. In the on state the processor 124 processes a digital signal received from the diagnostic system 106 via the output port/endpiece arrangement that corresponds to the distance travelled by the vehicle 100. The processor 124 converts the distance measured since the taxi meter 108 was switched on into a monetary value, typically this is achieved by incrementally increasing a counter when a pre-determined distance has been travelled. For example, a rate of C=0.90 per km may be the tariff and every time data corresponding to 1 km travelled is received from the diagnostic system 106 at the processor 124 the processor 124 increments a total tariff parameter by C=0.90.

The display 128 displays the value of the total tariff parameter 132. Furthermore, some of the input buttons 126 may be used to include fixed fare elements to the total tariff parameter 132. For example, a fixed fare elements of C=1.00 may be applied to each passenger above one within the vehicle 100. Accordingly, when the correct input button 126 is depressed the processor 124 is actuated and increases the total tariff parameter 132 by C=1.00.

In some embodiments one of the terminals 119 carries a steady output voltage, typically from the vehicle's battery, which can power signage 134 either internally, or externally, of the vehicle, for example a “For Hire” sign.

Referring now to FIG. 4, a connector 400 for connecting to a vehicle diagnostic system comprises an end piece 402 that is shaped complimentarily to an output port of the diagnostic system and a cable 404. The end piece 402 comprises a processor 406.

The processor 406 processes a digital signal received from the diagnostic system via the output port/endpiece arrangement that corresponds to the distance travelled by a vehicle. The processor 406 interprets the digital signal and outputs it to a taximeter (not shown) via the cable 404.

Typically, the processor 406 is powered by drawing power from the vehicle diagnostic system.

The taxi meter may be an analogue taximeter in which case the processor 406 outputs an analogue signal to the taximeter. The taximeter converts this analogue signal into a monetary value in a manner that is known to a man skilled in the art.

However, the taximeter may be a digital taximeter and the processor 406 may output either a digital signal corresponding to the distance travelled that suitably coded to interface with the taximeter. Alternatively, or additionally, the processor 406 may convert the digital signal received from the vehicle diagnostic system into a monetary value that is passed to the taximeter.

It will be appreciated that although described with reference to an arrangement having a connector the present invention is equally applicable to systems that are connected to a vehicle diagnostic system via wires rather than a connector arrangement.

1. A signal processing apparatus for a taxi meter comprising processing means and connection means, the connection means being arranged to connect to a vehicle's diagnostic system, the connection means being arranged to receive said incoming electrical signal from the vehicle's diagnostic system and to pass said incoming electrical signal to the processing means, the processing means being arranged to convert an incoming electrical signal from a vehicle's diagnostic system to distance data indicative of a distance traveled, the processing means being further arranged to interpret distance data into a form suitable for reading by a taximeter, and being further arranged to transmit said interpreted distance data.

2. Signal processing apparatus according to claim 1 that is arranged to connect to the vehicle's diagnostic system via a connector that is complimentary to that of the vehicle's diagnostic system.

3. Signal processing apparatus according to claim 1, wherein the connection means may be a controller area network (CAN) connector.

4. Signal processing apparatus according to claim 1, wherein the connection means comprises a shaped end-piece shaped complimentarily to the connector of the vehicle's diagnostic system.

5. Signal processing apparatus according to claim 4, wherein the end-piece and the connector are arranged to frictionally engage.

6. Signal processing means according to claim 1, wherein the connection means comprises a plug or a socket arranged to engage with a socket or a plug of the vehicle's diagnostic system.

7. Signal processing means according to claim 1, wherein the incoming electrical signal comprises odometer data.

8. Signal processing means according to claim 1, wherein the connection means is arranged to carry a voltage from the vehicle's diagnostic system.

9. Signal processing means according to claim 1, the voltage is arranged to power illuminated signage.

10. Signal processing means according to claim 1, wherein the processing means is arranged to convert said distance data to distance value data indicative of a monetary value associated with said distance data and being further arranged to add further value data to said distance value data if appropriate to yield a total value data.

11. Signal processing means according to claim 1, wherein the taximeter comprises display means arranged to display said total value data.

12. Signal processing means according to claim 1, wherein the processor is arranged to an output analogue signal.

13. (canceled)

14. (canceled)
